(19) United States
(12) Patent Application Publication
(10) Pub. No.: US 2023/0230138 A1
(43) Pub. Date: Jul. 20, 2023

(54) SYSTEM AND METHOD FOR VALIDATING PURCHASE OF RESTRICTED MERCHANDISE

(71) Applicant: Jim Collas, San Diego, CA (US)

(72) Inventor: Jim Collas, San Diego, CA (US)

(21) Appl. No.: 18/097,090

(22) Filed: Jan. 13, 2023

Related U.S. Application Data
(60) Provisional application No. 63/300,963, filed on Jan. 19, 2022.

(51) Int. Cl. G06Q 30/0601; G06Q 20/40

(52) U.S. Cl. CPC G06Q 30/0607; G06Q 20/4014

(57) ABSTRACT

A system configured to validate purchase of restricted merchandise by a purchasing customer includes a server configured to perform the following steps. (1) Store information that identifies a valid customer of the restricted merchandise including (a) a verified image of the customer and (b) device identity information unique to a mobile device of the valid customer. (2) Receive purchase request information from a point of sale device defining a purchase transaction of the restricted merchandise. (3) Receive decoded information from the point of sale device that identifies the valid customer and the device identity information. (4) Transfer the customer image to the point of sale device. (5) Receive confirmation information from the point of sale device that the customer image corresponds to the purchasing customer. (6) Authorize the purchase of restricted merchandise.

### CROSS-REFERENCE TO RELATED APPLICATIONS

This non-provisional application claims priority to U.S. Provisional Application Ser. No. 63/300,963, entitled “SYSTEM AND METHOD FOR VALIDATING PURCHASE OF RESTRICTED MERCHANDISE”, by Jim Collas, filed on Jan. 19, 2022, incorporated herein by reference under the benefit of U.S.C. 119(e).

### FIELD OF THE INVENTION

The present disclosure relates to validating identity information related to a transaction. More particularly, the present disclosure concerns validating during the process of effectuating a purchase transaction that a given customer is a valid customer for purchasing and receiving restricted merchandise that is subject to government regulation.

### BACKGROUND

There is a sizeable industry involved with the sale and distribution of restricted merchandise. Restricted merchandise can be defined as any product or substance whose sale may be restricted based upon various restriction factors related to the customer. Restriction factors can include one or more of age, permitting, licensing, clearances, or prescription.

The sale of restricted merchandise to unauthorized or underage customers can be a serious criminal offence. The burden is typically placed upon the merchant, who can be criminally liable even if a customer uses forged documents or a valid customer's personal information.

One way restricted merchandise has historically been sold is based upon display of an identification by a purchaser. Unfortunately, identifications can be invalid for some reason such as forgery, expiration, or an event that invalidates a previously valid identification. Further, the presenter of the identification may not be the person to which the identification belongs. Verifying identifications can put an undue burden on merchant personnel who then need to be experts on detection of forgeries and loss of validity. There is a need for a convenient method to provide high assurance that a given customer is authorized to purchase and acquire restricted merchandise.

### BRIEF DESCRIPTION OF THE FIGURES

FIG. 1 is a schematic block diagram of a system for enabling a validated or authenticated sale of restricted merchandise to a valid customer.

FIG. 2 is a flowchart representing a method for enrolling a new customer to become a valid customer.

FIG. 3 is a flowchart representing a method by which a valid customer is authorized to purchase and acquire restricted merchandise.

### SUMMARY

A first aspect of the disclosure is a computer-implemented method of validating a purchase of restricted merchandise by a purchasing customer. The method includes (1) storing information that identifies a valid customer of the restricted merchandise including (a) a verified image of the valid customer, and (b) device identity information unique to a mobile client device of the valid customer, (2) receiving purchase request information from a point of sale device defining a purchase transaction of the restricted merchandise, (3) receiving decoded information from the point of sale device that identifies the valid customer and the device identity information, (4) transferring the verified image to the point of sale device, (5) receiving confirmation information from the point of sale device that the verified image corresponds to the purchasing customer, (6) authorizing the purchase of restricted merchandise.

This method enables a rigorous validation of a potential customer's authorization to purchase the restricted merchandise without a need for a representative of the merchant to be highly skilled in identifying potential error or fraud. The stored photo identification assures the existence of a valid identification. The device identification assures that the mobile device being used is owned by the person of the photo identification. The transfer of the photo information to the merchant device allows the representative to easily verify that the photo identification corresponds to the purchaser.

In one implementation, the verified image includes an image of a previously validated government issued identification such as a driver's license. Additionally, the verified image can further include a self-image of the customer captured by the mobile device of the verified customer. The method can yet further include comparing the image of the government issued identification and the self-image captured by the mobile device to verify identity of the valid customer. This provides further validation that the person holding the mobile device is associated with the government issued identification.

In another implementation, the purchasing customer operates the mobile device to display a machine readable code and the point of sale device captures the machine readable code and extracts the decoded information.

In yet another implementation, the machine readable code is captured and then received in step (3) at a server. The server would then extract the decoded information which can be within the meaning of “receiving” the decoded information.

In a further implementation, the device identity information includes an International Mobile Equipment Identity (IMEI) number that is unique to the mobile device. The method includes associating the IMEI, the machine readable code, and the verified photo identification. The uniqueness of the IMEI and verified photo identification verify that the exact device being used is owned by a valid customer.

In a yet further implementation, the decoded information is based upon decoding a machine readable code displayed upon the mobile device of the valid customer. The decoded information further includes a time stamp based upon when the machine readable code was generated. The method further includes verifying validity of the decoded information based upon a comparison of the time stamp and a time at which the machine readable code was decoded. In particular, validating the purchase will fail if the time difference between decoding and generation is greater than a predetermined threshold.

In another implementation, the decoded information is based upon decoding a machine readable code displayed upon the mobile device of the valid customer. The decoded information further includes a locational information based upon where the machine readable code was generated. The method further includes verifying validity of the decoded information based upon a comparison of the locational information and a location of the point of sale device. The locational information can be a GPS signal captured by the mobile device when the machine readable code is generated. Validating the purchase will fail if a difference between the locational information and the location of the point of sale device is above a predetermined threshold.

A second aspect of the invention is a system configured to validate purchase of restricted merchandise by a purchasing customer. The system includes a server configured to, and includes: (1) stored information that identifies a valid customer of the restricted merchandise including (a) a verified image of the valid customer and (b) device identity information unique to a mobile device of the valid customer, (2) receive purchase request information from a point of sale device defining a purchase transaction of the restricted merchandise, (3) receive decoded information from the point of sale device that identifies the valid customer and the device identity information, (4) transfer the verified image to the point of sale device, (5) receive confirmation information from the point of sale device that the verified image corresponds to the purchasing customer, (6) authorize the purchase of restricted merchandise.

### DETAILED DESCRIPTION OF THE PREFERRED EMBODIMENTS

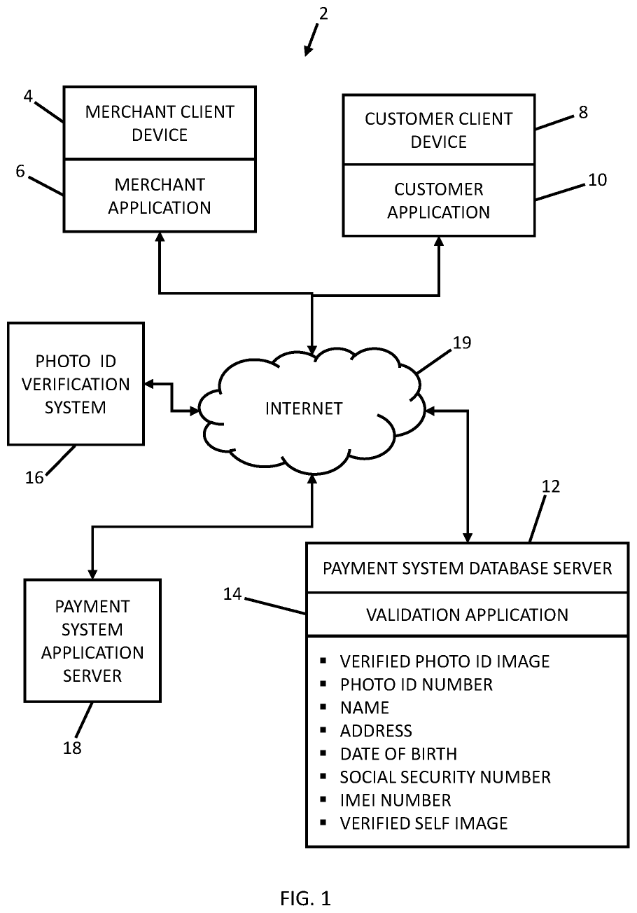

FIG. 1 is a schematic block diagram of a system 2 for enabling a validated or authenticated sale of restricted merchandise to a valid customer. A valid customer is defined as a customer that can legally purchase the restricted merchandise. The restricted merchandise can include any merchandise that is affected by government regulation which many limit and specify customers that can legally purchase the restricted merchandise. The government regulation may also affect other factors such as location and conditions of purchase. Additionally, the government re gulation may limit an amount of restricted merchandise that a given customer may purchase within some specified time period. Restricted merchandise can include, but is not limited to, alcohol, tobacco, lottery tickets, cannabis, chemicals, and firearms.

System 2 includes a merchant client (point of sale) device 4 which is used by a retail or wholesale distributor of the restricted merchandise. The merchant client device 4 can be a mobile client such as a “smartphone” or tablet computer. Alternatively, the merchant client device 4 can be a “desktop” or “countertop” device. The merchant client device 4 includes an image capture device (not shown) such as a camera or a hand-held scanner. The image capture device can be integrated into the merchant client device 4 or can be a separate device that is linked to the merchant client device 4 by a wired and/or wireless interface. The merchant client device 4 includes a non-transient storage device that stores software instructions that define a merchant application 6.

A customer client device 8 is used by the valid customer. The customer client device 8 is a mobile client device such as a smartphone. The customer client device 8 includes an image capture device such as a camera. The customer client device 8 includes a non-transient storage device that stores software instructions defining a customer application 10. The non-transient storage device also stores device identity information that uniquely identifies the customer client device 8. In an illustrative embodiment, the device identity information includes an International Mobile Equipment Identity (IMEI) number.

A payment system database server 12 is configured to validate customers and purchases of restricted merchandise by valid customers. The payment system database server 12 includes a non-transient storage device that stores software instructions defining a validation application 14 that stores valid customer account information. For a given valid customer the stored information can include a verified photo identification image, a verified photo identification number, a name, a street address, a data of birth (DOB), a social security number (SSN), a driver's license number, the IMEI number, and a verified self-image.

System 2 includes a photo ID verification system 16 which is part of a service used by server 12 to validate a government-issued photo identification. System 2 also includes a payment system 18 used during sale of the restricted merchandise. All components of system 2 are coupled via a computer network 19 or Internet 19.

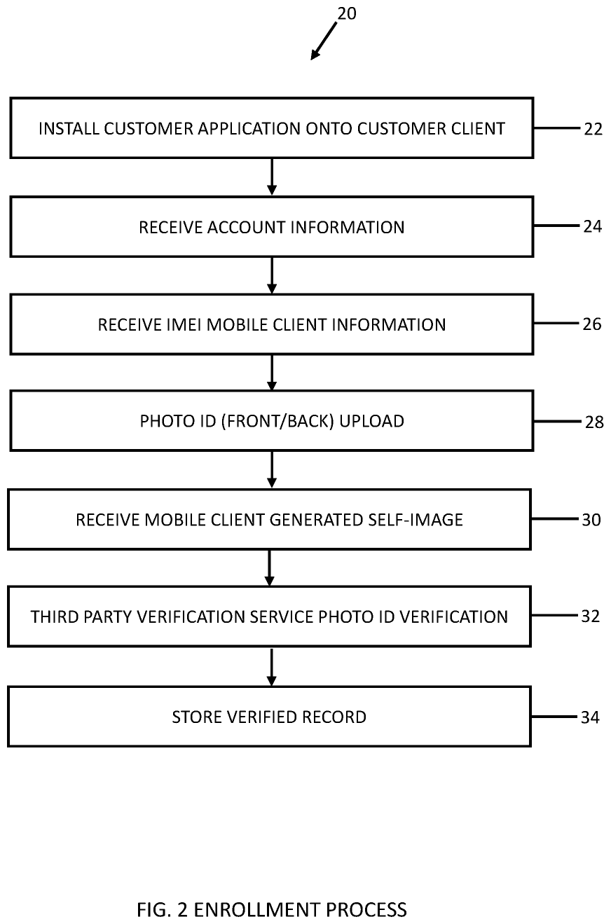

FIG. 2 is a flowchart representing a method 20 for enrolling a new customer to become a valid customer. A “valid customer” is one that can legally use system 2 to purchase the restricted merchandise and has been verified to be a valid customer. The new customer owns a customer client device 8. In an illustrative embodiment, the device 8 is a mobile device or smartphone having an image capture device or camera. Method 20 includes steps 22-34. It is to be understood that the order of steps 24-3 can vary. Thus, steps 24-3 are an example of a possible sequence of steps for validating a customer account.

According to 22, the customer application 10 is installed onto the customer client device 8. According to 24, server 12 receives initial account information from customer client device 8. This can include the new customer's full name, street address, and other identifying information. According to 26, the server 12 receives the International Mobile Equipment Identity (IMEI) number from the customer client device 8.

According to 28, the new customer uses customer client device 8 camera to capture front and back images of the new customer's government-issued photo identification. The government-issued photo identification can be a driver's license, a passport card, or other such identification. Also according to 28, the server 12 receives front and back images of a government-issued photo identification of the new customer.

According to 30, the new customer uses customer client device 8 camera to capture a self-image of the new customer. Also according to 30, the self-image is received by server 12.

According to 32, the server 12 interacts with and queries a photo ID verification system 16 to verify validity of the government-issued photo identification. Step 32 can include three separate steps: (32A) Server 12 transfers images of the government-issued photo identification to system 16 which then verifies validity of the government-issued photo identification. (32B) Server 12 transfers a self-image obtained by the new customer using the new customer's client device 8 (e.g., smartphone camera) to system 16 which then verifies that the self-image matches the image from the government issued photo identification. (32C) The server 12 sends other new customer information (e.g., name, address, date of birth, social security number, driver's or other license number) which then verifies this information in conjunction with the images. Once step 32 is complete, the image of the government-issued photo identification or the self-image can be referred to as a verified image or previously verified image.

Once all the information received by server 12 and system 16 is verified, a verified record for the new customer is stored on server 12. The new customer is now a “valid customer”. The verified record, as illustrated in FIG. 1, includes the government issued photo identification image, the self-image, and other information that is correlated and linked to the International Mobile Equipment Identity (IMEI) number of the mobile device 8. The valid customer as defined by the stored record is now authorized to purchase the restricted merchandise.

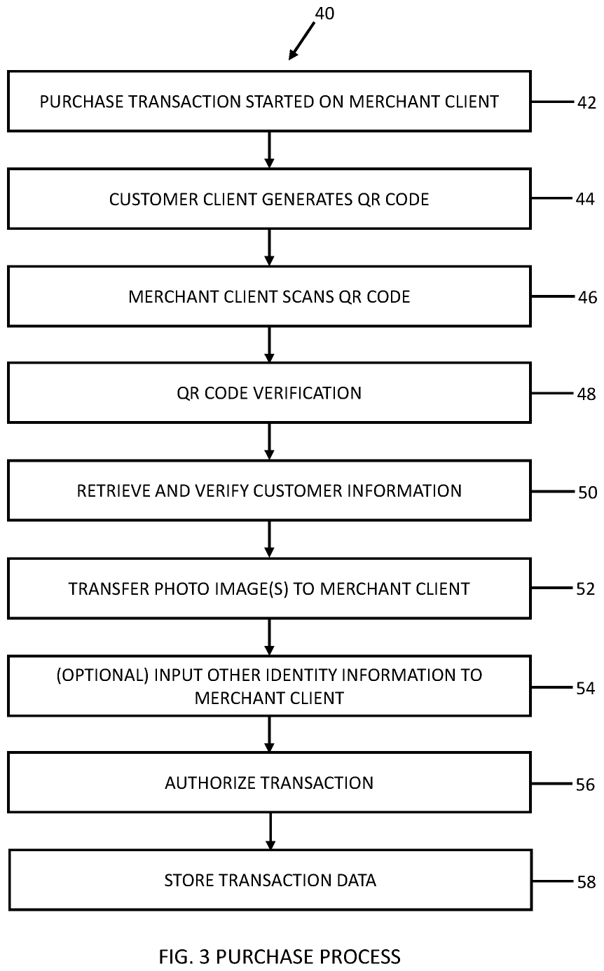

FIG. 3 is a flowchart representing a method 40 by which a valid customer is authorized to purchase restricted merchandise. According to 42, a merchant representative operates a merchant client device 4 to run the customer application 10 and to start a purchase transaction process.

According to 44, the customer client device 8 is used by the valid customer to generate a machine readable code (e.g., QR code, quick response code, barcode, two-dimensional barcode, to list some examples). The machine readable code is unique to the customer client device 8 and the machine readable code carries the device identity information (e.g., IMEI). The machine readable code also carries a time stamp of when it was generated as well as global positioning system (GPS) data indicating where it was generated.

According to 46, the merchant client 4 scans or captures and reads the machine readable code. The merchant client 4 extracts the information carried by the machine readable code including an identity of the purchasing customer, the device identity information, the time stamp, and the GPS code which is now referred to as “decoded information”. The decoded information is then sent by the merchant client 4 and received by the server 12.

According to 48, the server 12 verifies the decoded information including by comparing it against records stored by the validation application (including database) 14. As part of 48, the server 12 verifies that the valid customer is using the correct customer client device 8 according to the IMEI number. The server 12 verifies that the time stamp for generating the machine readable code was within a predetermined timeframe. The server 12 also verifies that the GPS code corresponds to the location of the merchant client 4.

According to 50, assuming that the decoded information is valid, the server 12 retrieves additional information and images for the valid customer. According to 52, the server 12 transfers a verified image for the verified customer to the merchant client 4. The verified image(s) can include a photograph from a government-issued photo identification and/or a self-image. Also according to 52, the merchant verifies the verified image(s) versus an appearance of the purchasing customer. If there is a match, the merchant uses merchant client 4 to send a confirmation of image matching which is received by the server 12.

As an additional possible step, the merchant may decide that collecting additional verification information is required such as a birthdate or a portion of a social security number. According to 56, the server 12 provides an authorization for the sale of the restricted merchandise to the merchant client device 8. According to 58, a record of the transaction is stored. As part of steps 56 and 58, the transaction takes place.

Method 40 embodies four and optionally five integrity checks to verify that the purchasing customer is the valid customer. These integrity checks help to prevent fraud, in which a person who is not a valid customer attempts to pose as a valid customer.

Integrity Check 1: During the enrollment process 20, the customer client device 8 IMEI number is linked to the verified record and account for the valid customer. This prevents an invalid customer from using a different phone to purchase the restricted merchandise. Thus there is a one-to-one relationship between an IMEI number and consumer identity account. If the valid customer obtains a new smartphone or mobile phone, server 12 will detect the new device with a new IMEI number and require some steps of the enrollment process 20 to be repeated.

Integrity Check 2: When a customer attempts to generate a machine readable code in step 44, the IMEI number of the phone being used is compared with the verified customer account. If the IMEI number does not correspond with the valid customer account, the attempt to generate machine readable code will be blocked.

Integrity Check 3: The machine readable code stores a time stamp and location information. During step 48, the time stamp and location information is verified. Once generated, the machine readable code is only valid for a short time period and at the location of generation. This helps to prevent a machine readable code from being transferred from one device to another before use. This increases likelihood that the purchasing customer is the valid customer.

Integrity Check 4: The merchant checks the images received from the server 12 versus the appearance of the purchasing customer. The merchant can then determine whether the purchasing customer is the valid customer.

Integrity Check 5: The merchant can require and input additional information specific to the purchasing customer if there is any residual concern.

The specific embodiments and applications thereof described above are for illustrative purposes only and do not preclude modifications and variations encompassed by the scope of the following claims.

What is claimed:

1. A computer-implemented method of validating a purchase of restricted merchandise by a purchasing customer comprising:
storing information that identifies a valid customer of the restricted merchandise including:
a verified image of the valid customer;
device identity information unique to a mobile device of the valid customer;
receiving purchase request information from a point of sale device defining a purchase transaction of the restricted merchandise;
receiving decoded information from the point of sale device that identifies the valid customer and the device identity information;
transferring the verified image of the valid customer to the point of sale device;
receiving confirmation information from the point of sale device that the verified image of the valid customer corresponds to the purchasing customer; and
authorizing the purchase of restricted merchandise.

2. The method of claim 1 wherein the verified image includes an image of a previously validated government issued identification.

3. The method of claim 1 wherein the verified image further includes a self-image of the valid customer captured by the mobile device of the valid customer.

4. The method of claim 1 further comprising:
generating and displaying a machine readable code upon the mobile device of the valid customer;
operating the point of sale device to capture an image of the machine readable code from the mobile device of the valid customer; and
operating the point of sale device to extract the decoded information from the machine readable code.

5. The method of claim 1 wherein the device identity information includes an International Mobile Equipment Identity (IMEI) number that is unique to the mobile device.

6. The method of claim 1 wherein the decoded information is based upon decoding a machine readable code generated upon the mobile device of the valid customer, the decoded information further includes a time stamp based upon when the machine readable code was generated, the method further including verifying validity of the machine decoded information based upon a comparison of the time stamp and a time at which the machine readable code was decoded.

7. The method of claim 1 wherein the decoded information is based upon decoding a machine readable code displayed upon the mobile device of the valid customer, the decoded information further includes locational information based upon where the machine readable code was generated, the method further including verifying validity of the decoded information based upon a comparison of the locational information and a location of the point of sale device.

8. A system configured to validate purchase of restricted merchandise by a purchasing customer including a server configured to:
store information that identifies a valid customer of the restricted merchandise including:
a verified image of the valid customer;
device identity information unique to a mobile device of the valid customer;
receive purchase request information from a point of sale device defining a purchase transaction of the restricted merchandise;
receive decoded information from the point of sale device that identifies the valid customer and the device identity information;
transfer the verified image to the point of sale device;
receive confirmation information from the point of sale device that the verified image corresponds to the purchasing customer; and
authorize the purchase of restricted merchandise.

9. The system of claim 8 wherein the verified image includes an image of a previously validated government issued identification.

10. The system of claim 8 wherein the verified image further includes a self-image of the valid customer captured by the mobile device of the valid customer.

11. The system of claim 8 wherein the device identity information includes an International Mobile Equipment Identity (IMEI) number that is unique to the mobile device.

12. The system of claim 8 wherein the decoded information is based upon decoding a machine readable code displayed upon the mobile device of the valid customer, the decoded information further includes a time stamp based upon when the machine readable code was generated, the server is further configured to verify a validity of the decoded information based upon a comparison of the time stamp and a time at which the machine readable code was decoded.

13. The system of claim 8 wherein the decoded information is based upon decoding a machine readable code displayed upon the mobile device of the valid customer, the decoded information further includes locational information based upon where the machine readable code was generated, the server is further configured to verify a validity of the decoded information based upon a comparison of the locational information and a location of the point of sale device.

14. A non-transient storage device storing software instructions that when executed by a processor are configured to validate purchase of restricted merchandise by a purchasing customer according to the following steps:
storing information that identifies a valid customer of the restricted merchandise including:
a verified image of the valid customer;
device identity information unique to a mobile device of the valid customer;
receiving purchase request information from a point of sale device defining a purchase transaction of the restricted merchandise;
receiving decoded information from the point of sale device that identifies the valid customer and the device identity information;
transferring the verified image to the point of sale device;
receiving confirmation information from the point of sale device that the verified image corresponds to the purchasing customer; and
authorizing the purchase of restricted merchandise.

15. The non-transient storage device of claim 14 wherein the verified image includes an image of a previously validated government issued identification.

16. The non-transient storage device of claim 14 wherein the verified image further includes a self-image of the valid customer captured by the mobile device of the valid customer.

17. The non-transient storage device of claim 14 wherein the device identity information includes an International Mobile Equipment Identity (IMEI) number that is unique to the mobile device.

18. The non-transient storage device of claim 14 wherein the decoded information is based upon decoding a machine readable code displayed upon the mobile device of the valid customer, the decoded information further includes a time stamp based upon when the machine readable code was generated, the steps further including verifying validity of the machine decoded information based upon a comparison of the time stamp and a time at which the machine readable code was decoded.

19. The non-transient storage device of claim 14 wherein the decoded information is based upon decoding a machine readable code displayed upon the mobile device of the valid customer, the decoded information further includes locational information based upon where the machine readable code was generated, the steps further including verifying validity of the machine decoded information based upon a comparison of the locational information and a location of the point of sale device.
